(19) United States
(12) Patent Application Publication
(10) Pub. No.: US 2018/0147701 A1
(43) Pub. Date: May 31, 2018

(54) FIXINGLY POSITIONED FOLDING TOOL

(71) Applicant: Yi-Feng LIU, New Taipei (TW)

(72) Inventor: Yi-Feng LIU, New Taipei (TW)

(21) Appl. No.: 15/364,763

(22) Filed: Nov. 30, 2016

(51) Int. Cl. B25B 23/00; B25F 1/04; B25F 1/00; B25B 15/00

(52) U.S. Cl. CPC B25B 23/0028; B25B 15/008; B25F 1/003; B25F 1/04

(57) ABSTRACT

A fixingly positioned folding tool comprises a housing, a supporting plate within the housing, tool portions, a fixing portion and a positioning unit. The tool portion comprises a positioning part provided with notches and a tool part fixed to the positioning part. The fixing portion comprises a fixing part and a screwing part. The positioning unit comprises an elastic part and a positioning tab. A first end of the positioning tab is pressed by the elastic part, such that a second end of the positioning tab is located at a first position, where the tool part and supporting plate are located at a first angle while fixed together. When the first end of positioning tab is pressed to compress the elastic part, the second end of positioning tab is located at a second position, where the tool part and supporting plate are moved within a range of a second angle.

### FIELD OF THE INVENTION

The present invention is related to a folding tool, particularly to a fixingly positioned folding tool.

### BACKGROUND OF THE INVENTION

Generally, in most working tools, one function is provided for one single grip. The grip is capable of increasing the rotational torque of the working tool for the convenience of handling. However, working tools of various functions are commonly needed on working places. In this case, a significantly increased number of tools should be carried. To solve the above problem, working tools of various functions are integrated together by tool developers.

For instance, in Taiwan patent no. I430874, there is disclosed a folding tool set, mainly comprising a main body, a first shaft, a first tool unit, a second shaft and a second tool unit. The main body is provided with two lateral plates in parallel at left and right sides, and a first accommodating room defined to pass through the two lateral plates transversely, as well as is further integrally connected with bridging portions above and below the first accommodating room. This main body is additionally provided with a second accommodating room defined between the two lateral plates while opened upward and forward. The first shaft is allowed for bridging the two bridging portions longitudinally, and is located at the front edge of the first accommodating room. One end of the first tool unit is pivoted about the first shaft, while the other end thereof is used as a handling portion, such that handling portions of the tools are capable of passing in and out of the first accommodating room around the first shaft as a fulcrum. The second shaft is allowed for spanning the second accommodating room between the two lateral plates transversely, and located in front of the first shaft relatively. The first and second shafts are then arranged in an orthogonal and staggered manner. One end of the second tool unit is pivoted about the second shaft, while the other end thereof is used as a handling portion, such that handling portions of the tools are capable of passing in and out of the second accommodating room around the second shaft as a fulcrum. The sense of rotation of the second tool unit is perpendicular to that of the first tool unit.

In the above prior art, the first tool unit and the second tool unit are incapable of being fixed at a specific angle when moved out of the main body. Thus, the tool units are apt to sway to lead to instability in operation, when the folding tool set is used for working.

### SUMMARY OF THE INVENTION

It is the main object of the present invention to solve the problem of poor stability of the conventional folding tool set in operation.

For achieving the above object, the present invention provides a fixingly positioned folding tool, comprising a housing, a supporting plate, a plurality of tool portions, a fixing portion and a positioning unit. The housing is provided with a first side wall and a second side wall provided separately from the first side wall. The supporting plate is provided between the first side wall and the second side wall. The tool portion comprises a positioning part provided with a plurality of notches and a tool part fixed to the positioning part. The fixing portion comprises a fixing part passing through the first side wall, the second side wall, the supporting plate and the tool portions, and a screwing part provided correspondingly to the fixing part. The positioning unit comprises an elastic part provided at one side of the supporting plate, and a positioning tab in contact with the elastic part. In this case, a first end of the positioning tab is pressed by elastic stress of the elastic part toward a direction far away from the supporting plate, in such a way that a second end of the positioning tab is located at a first position, where the positioning tab is retained in the notch such that the tool part and the supporting plate are located at a first angle while are fixed to each other. When the first end of the positioning tab is pressed to compress the elastic part, the second end of the positioning tab is located at a second position, where the positioning tab is far away from the notch such that the tool part and the supporting plate are moved within a range of a second angle.

It is known from the above that the effect to be achieved by the present invention in comparison with the prior art is controlling the positioning part of the tool portion by the positioning unit such that the tool part and the supporting plate are located at the first angle with respect to each other and fixed to each other. When the fixingly positioned folding tool at the fixed angle is used, the stability in operation may be enhanced significantly.

### BRIEF DESCRIPTION OF THE DRAWINGS

FIG. 1 is an exploded diagram of a fixingly positioned folding tool of one embodiment of the present invention.

FIG. 2 is an exploded diagram of a tool portion of one embodiment of the present invention.

FIG. 3 is a diagram of handling a fixingly positioned folding tool of a first embodiment of the present invention.

FIG. 4 is a diagram of handling a fixingly positioned folding tool of a second embodiment of the present invention.

FIG. 5 is a diagram of handling a fixingly positioned folding tool of a third embodiment of the present invention.

### DETAILED DESCRIPTION OF THE PREFERRED EMBODIMENTS

The detailed description and technical solution with respect to the present invention will be now described in conjunction with the drawings as follows.

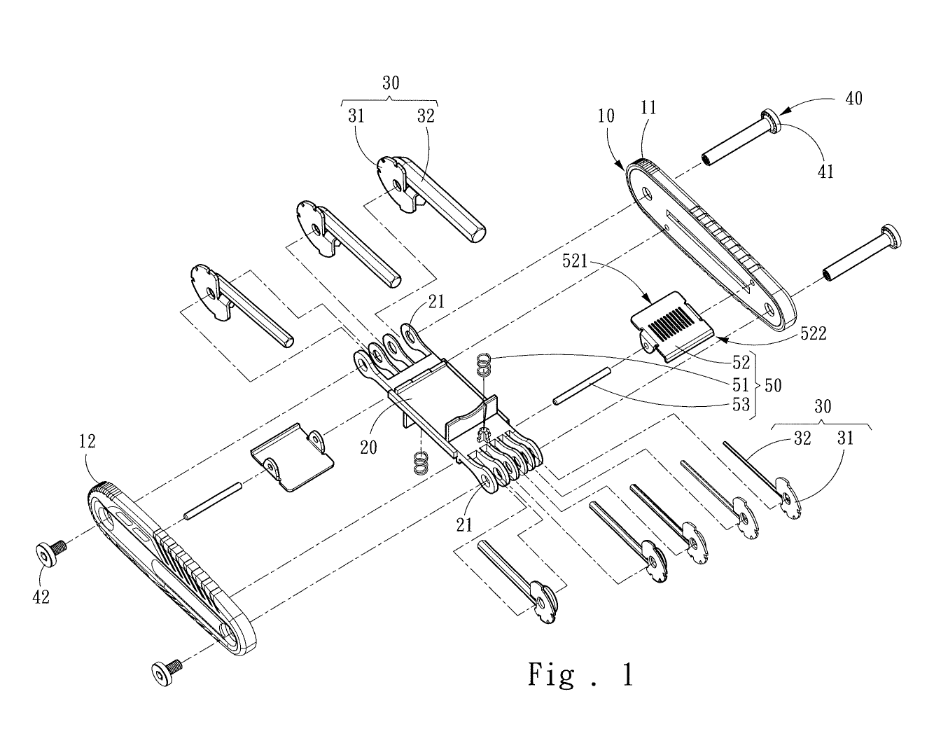

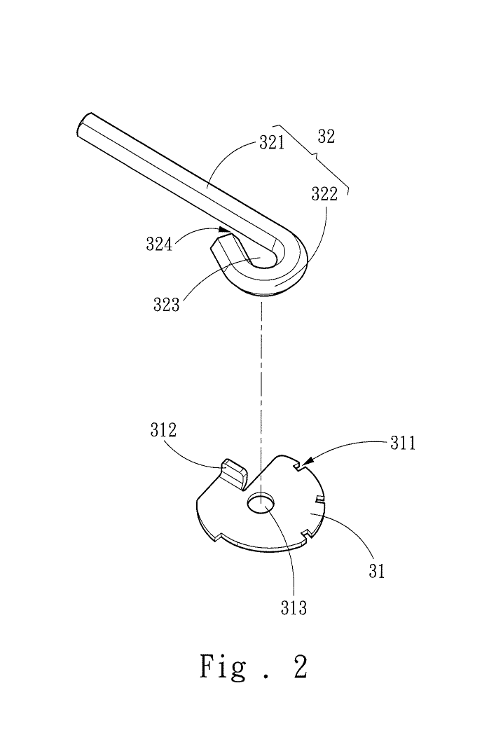

Referring to FIGS. 1 and 2 together, there are shown an exploded diagram of a fixingly positioned folding tool of an embodiment of the present invention, and an exploded diagram of a tool portion, respectively. The present invention is related to a fixingly positioned folding tool, comprising a housing 10, a supporting plate 20, a plurality of tool portions 30, a fixing portion 40 and a positioning unit 50. The housing 10 is provided with a first side wall 11 and a second side wall 12, the second side wall 12 being provided separately from the first side wall 11. The supporting plate 20 is provided between the first side wall 11 and the second side wall 12, while is provided with a plurality of first through-holes 21 extending transversely and openly provided toward a longitudinal direction.

The tool portion 30 comprises a positioning part 31 and a tool part 32, in which the positioning part 31 is provided on an outer edge thereof with a plurality of notches 311 and a projecting rib 312, respectively. The projecting rib 312 is provided in a vertical direction with respect to a plane of the positioning part 31, and then provided for the tool part 32 to be clamped. The positioning part 31 is provided at a center thereof with a second through-hole 313. In this embodiment, the tool part 32 is provided with a linear segment 321 and a curved segment 322. The curved segment 322 is coiled to form a third through-hole 323, while one end of the curved segment 322 is provided separately from one side of the linear segment 321 to form a slit 324, as illustrated in FIG. 2. The tool part 32 is fixed to the projecting rib 312 of the positioning part 31 together via the slit 324. In this embodiment, the tool part 32 may be a wrench, a driver, pliers or the combination thereof. In this connection, the wrench may be an internal hexagonal wrench, a box wrench or an adjustable wrench, the driver may be a minus driver or a plus driver, and the pliers may be needle-nose pliers or diagonal pliers, for example. The above tools are taken for example without limiting thereto.

The fixing portion 40 comprises a fixing part 41 and a screwing part 42. The fixing part 41 is allowed for passing through the first side wall 11, the second side wall 12, the first through-holes 21 of the supporting plate 20, the second through-holes 313 of the positioning parts 31 and the third through-holes 323 of the tool parts 32. The screwing part 42 and the fixing part 41 are provided correspondingly, such that the supporting plate 20 is fixed to the first side wall 11 and the second side wall 12, respectively, while the tool portion 30 is rotated about an axial center of the fixing part 41.

The positioning unit 50 comprises an elastic part 51, a positioning tab 52 and a strut 53. The elastic part 51 is provided at one side of the supporting plate 20. The strut 53 is fixed between the first side wall 11 and the second side wall 12, and allowed for carrying the positioning tab 52. The positioning tab 52 is rotated through the strut 53, and contacted with the elastic part 51. In this embodiment, the elastic part 51 may be a spring or a spring leaf.

In another embodiment, the tool portions 30 and the fixing portions 40 are divided into two groups, each being provided at left or right end of the supporting plate 20, respectively. There may be two groups of the positioning units 50, each being provided at top or bottom side of the supporting plate 20. Another group of the tool portions 30, the fixing portion 40 and the positioning unit 50 is provided in a manner similar to that of the previous embodiment and should not be described further.

In the present invention, a first end 521 of the positioning tab 52 is pressed by elastic stress of the elastic part 51 toward a direction far away from the supporting plate 20, in such a way that a second end 522 of the positioning tab 52 is located at a first position, where the positioning tab 52 is retained in the notch 311 such that the tool part 32 and the supporting plate 20 are located at a first angle while are fixed to each other. When the first end 521 of the positioning tab 52 is pressed to compress the elastic part 51, the second end 522 of the positioning tab 52 is located at a second position, where the positioning tab 52 is far away from the notch 311 such that the tool part 32 and the supporting plate 20 are moved by a second angle ranging from 0° to 180°. In this connection, the tool part 32 is accommodated within the housing 10 when the second angle is 0°, while the tool part 32 is moved to the outside of the housing 10 and to be in parallel with the supporting plate 20 when the second angle is 180°.

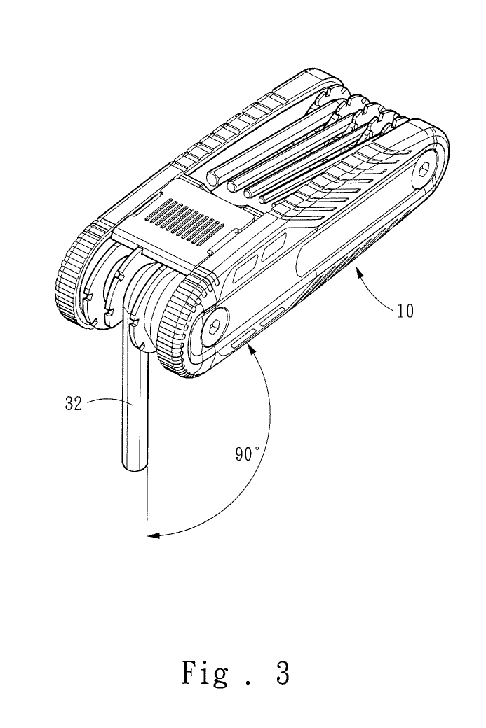

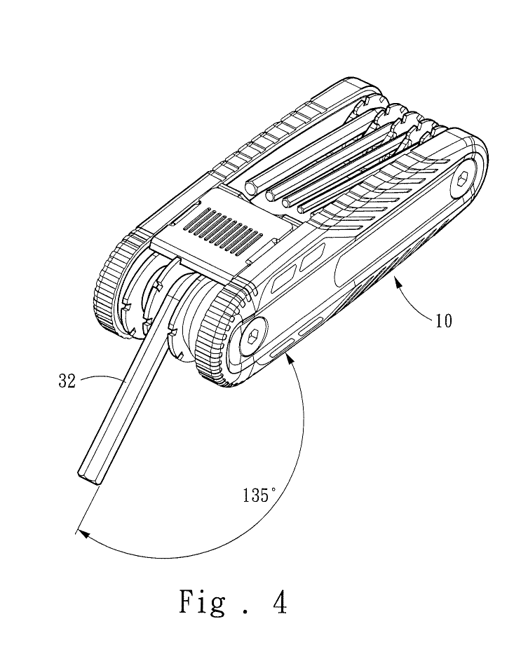

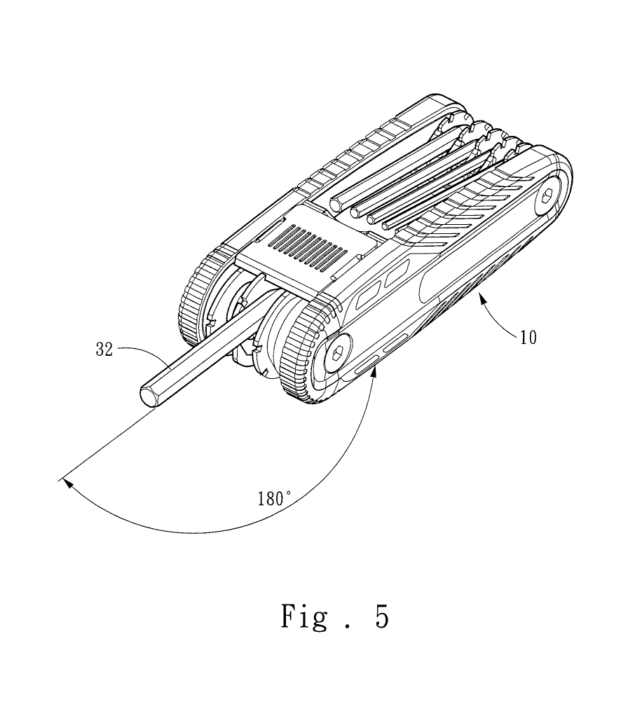

In the practical operation, when it is required to use the fixingly positioned folding tool, the first end 521 of the positioning tab 52 is pressed to move the second end 522 away from the notch 311. At this time, the tool part 32 may be moved within a range of the second angle, i.e., the positioning part 31 moving together with the tool part 32 around the axial center of the fixing part 41. When the tool part 32 is moved to the desirably adjusted first angle, the positioning tab 52 is released, such that the positioning tab 52 may be returned to the first position due to elastic stress, and at the same time, retained in the notch 311. At this time, the tool part 32 and the supporting plate 20 are located at the first angle. When the adjustment of the first angle of the tool part 32 and the supporting plate 20 is desired, it is only necessary to press the first end 521 of the positioning tab 52 again. In this case, referring to FIGS. 3 to 5 together, the first angle may be 90°, 135° and 180°, respectively. The above angles are merely taken as examples in the present invention, and may be various angles designed as required practically without limiting thereto.

To sum up, the positioning part of the tool portion is controlled by the positioning unit, such that the tool part and the supporting plate are located at the first angle with respect to each other and fixed to each other. In comparison with conventional folding tool set of non-fixing design, the stability in operation may be significantly enhanced in the fixingly positioned folding tool of the present invention.

What is claimed is:

1. A fixingly positioned folding tool, comprising:
a housing, provided with a first side wall and a second side wall provided separately from said first side wall;
a supporting plate, provided between said first side wall and said second side wall;
a plurality of tool portions, each comprising a positioning part provided with a plurality of notches and a tool part fixed to said positioning part;
a fixing portion, comprising a fixing part passing through said first side wall, said second side wall, said supporting plate and said tool portions, and a screwing part provided correspondingly to said fixing part; and
a positioning unit, comprising an elastic part provided at one side of said supporting plate, and a positioning tab in contact with said elastic part;
wherein a first end of said positioning tab is pressed by elastic stress of said elastic part toward a direction far away from said supporting plate, in such a way that a second end of said positioning tab is located at a first position, where said positioning tab is retained in said notch such that said tool part and said supporting plate are located at a first angle while are fixed to each other, as well as when said first end of said positioning tab is pressed to compress said elastic part, said second end of said positioning tab is located at a second position, where said positioning tab is far away from said notch such that said tool part and said supporting plate are moved within a range of a second angle.

2. The fixingly positioned folding tool according to claim 1, wherein said tool part is selected from the group consisting of a wrench, a driver and pliers.

3. The fixingly positioned folding tool according to claim 1, wherein said elastic part is a spring or a spring leaf.

4. The fixingly positioned folding tool according to claim 1, wherein said first angle is selected from the group consisting of 90°, 135° and 180°.

5. The fixingly positioned folding tool according to claim 1, wherein said second angle is in the range of 0° to 180°.

6. The fixingly positioned folding tool according to claim 1, wherein said tool part is provided with a linear segment and a curved segment, one end of said curved segment being provided separately from one side of said linear segment to form a slit.

7. The fixingly positioned folding tool according to claim 6, wherein said tool part is fixed to a projecting rib of said positioning part together via said slit.
